(19) United States
(12) Patent Application Publication
(10) Pub. No.: US 2015/0137620 A1
(43) Pub. Date: May 21, 2015

(54) ANTI-INTERFERENCE SWITCH SIGNAL TRANSMISSION CIRCUIT

(71) Applicant: Beijing Sifang Automation Co., Ltd., Beijing (CN)

(72) Inventors: Gang Xu, Beijing (CN); Tao Zhang, Beijing (CN); An Liu, Beijing (CN); Qiurong Chen, Beijing (CN); Wenhao Shi, Beijing (CN)

(73) Assignee: Beijing Sifang Automation Co., Ltd., Beijing (CN)

(21) Appl. No.: 14/405,449

(22) PCT Filed: Aug. 23, 2013
(86) PCT No.: PCT/CN2013/000998

§ 371 Date: Dec. 4, 2014

(30) Foreign Application Priority Data
Aug. 27, 2012 (CN) 201210307955.2

(51) Int. Cl. H01H 47/00

(52) U.S. Cl. CPC H01H 47/00
USPC 307/139

(57) ABSTRACT

An anti-interference switch signal transmission circuit, in which a changeover contact is used at a signal terminal, wherein a normally closed contact is connected to DC−, a normally open contact is connected to DC+, and a common terminal is connected to a switch signal acquisition circuit. When no signal exists, DC− is connected to a positive input terminal of the switch signal acquisition circuit via the normally closed contact. Since a negative input terminal of the switch signal acquisition circuit is also connected to DC−, even if interference is caused, no false signal is generated. When a signal exists, the position of the changeover contact changes and DC+ is connected to DC− via the closed normally open contact through the switch signal acquisition circuit thus a loop is formed, so that the signal can be reflected. The interference problem is solved by connecting both the two terminals of the acquisition circuit to DC− when no signal exists.

### FIELD OF THE INVENTION

The present invention generally relates to switch signal transmission and relay protection in electric power system, and more particularly, to a design of anti-interference switch signal transmission circuit which solves the problem of interference by dredging instead of avoiding it.

### BACKGROUND OF THE INVENTION

In a power system, many information of equipments such as location and state information need to be transmitted by a switch or digital signal, especially between primary equipments, between secondary equipment, or between primary equipment and secondary equipment in a power plant and a transformer substation. Generally, it is achieved by using dry contact at a signal terminal to switch signal, which remains open when no signal input exists in this system and become closed when input signal comes in. Meanwhile, a switch signal acquisition circuit is arranged at a receiving terminal, in this way it could form a loop between DC+, the dry contact, the switch signal acquisition circuit, and DC−. When there is no signal in this system, the contact open, in this way, there is no current in the acquisition circuit. On the other hand, when there are signals, the contact closed, the acquisition circuit is ON in order to output the correct signals. Nonetheless, the existence of the distributed capacitance, AC interfusion, and/or control cable crosstalk on site always lead to wrong signal output in the transmission process of the switch signals due to interference. The general solutions for this problem are as follows:

1) Debouncing function is added in the switch signal acquisition circuit to avoid the period of interference.

2) Increasing the drive current of the switch signal acquisition circuit to escape the interference circuit.

However, both these two approaches have limitations. Thus the interference problem cannot be fundamentally solved. For example, AC interfusion could not be completely solved.

### SUMMARY OF THE INVENTION

In order to solve the existing problems in the prior art, an anti-interference switch signal transmission circuit is provided.

The transmission circuit includes a changeover contact, a negative terminal of a DC power supply DC−, a positive terminal of the DC power supply DC+, and a switch signal acquisition circuit;

wherein the changeover contact includes a normally open contact and a normally closed contact;

wherein the changeover contact is controlled by a signal terminal to be collected;

wherein a collection terminal of the switch signal acquisition circuit is connected to the switch signal to be collected;

wherein one terminal of the switch signal acquisition circuit is linked with the positive terminal DC+ by the normally open contact, and the other terminal is connected to DC−;

wherein one terminal of the switch signal acquisition circuit is linked with the negative terminal DC− by the normally closed contact, and the other terminal is connected to DC−;

wherein when no switch signal occurs, the normally open contact open and the normally closed contact closed, the circuit level of the switch signal acquisition circuit is always in the negative DC power status; and

wherein when there are switch signals, the normally closed contact open and the normally open contact closed, the positive terminal DC+ is connected to the negative terminal DC− via the closed normally open contact so as to form a loop, thus the switch signal acquisition circuit is ON.

The present invention provides additional contact wiring. In this way, the changeover contact is controlled by the signal terminal. When there is no switch signal, DC− is connected with the normally closed contact, thus the loop level is always at DC− State so that the output could not be changed by outside interference. When there are signals, position of the changeover contact will change. DC+ is connected to DC− via the closed normally open contact, so as to output correct signals.

This invention has changed the original position status of the contact of the acquisition circuit without switch signal transmission. That is, a DC− cable is added to link with the normally closed contact of the changeover contact. In this case, when there is no signal in the system, both the two terminals of the switch signal acquisition circuit are connected with DC− so that it will not be affected by the outside interference.

The technical effects of the invention are as follows:

1. The invention solves the interference problem by dredging instead of evasive way.

2. The invention has solved the interference problem by connecting both terminals of the switch signal acquisition circuit to DC− when there are no signals in the system.

3. The state with or without switch signal is switched by the operation mode of the changeover contact.

### BRIEF DESCRIPTION OF THE DRAWINGS

FIG. 1 shows a schematic illustration of a prior art switch signal transmission circuit.

FIG. 2 schematically illustrates an anti-interference switch signal transmission circuit in accordance with an embodiment of the present invention.

### DETAILED DESCRIPTION OF THE PREFERRED EMBODIMENTS

The present invention will be more fully understood from the following detailed description of embodiments thereof, taken together with the drawings.

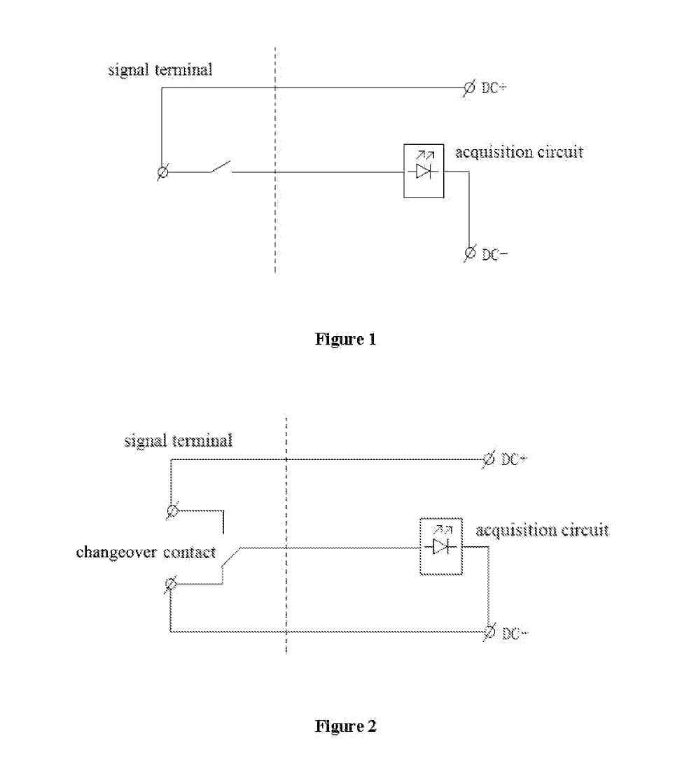

FIG. 1 is a schematic illustration of a prior art switch signal transmission circuit. DC+ is connected to a switch signal acquisition circuit via a normally open contact. When there are switch signals in the system, the signal terminal controls the normally open contact to be closed so as to form a loop by DC+, the closed normally open contact, the switch signal acquisition circuit, and DC−. As a result, the switch signal acquisition circuit is connected and thus reflects the switch signals. The problem of this kind of wiring is that it is so close between individual switch signal transmission cables. When there is no switch signal in one cable, it may play a role of an antenna to receive the interference from the other cables. When the interference reaches certain intensity, the acquisition circuit will mistakenly consider the interference as switch signal and thus make error.

FIG. 2 illustrates an anti-interference switch signal transmission circuit in accordance with an embodiment of the present invention. In this circuit, at the signal terminal, DC+is connected to the normally open contact of the changeover contact, and DC− is connected to the normally closed contact of the changeover contact, and the common terminal of the changeover contact is connected to the switch signal acquisition circuit. A control coil of the changeover contact is serially connected into the control loop at the signal terminal (not shown). On the side of the acquisition circuit, the negative terminal of the circuit is connected with DC− and the positive terminal thereof is linked with the common terminal. When the control coil is not electrified, DC− is connected to the positive input terminal of the switch signal acquisition circuit via the normally closed contact. Since the electric potentials at the two terminals of the switch signal acquisition circuit is same, outside interference is reduced. When the control coil is electrified (to control the action of the changeover contact), DC+ is connected to the positive input terminal of the switch signal acquisition circuit via the closed normally open contact, there is a difference in electric potentials at the two terminals of the acquisition circuit, thus a switch signal is collected.

In this invention, a DC− cable is added into each switch signal transmission loop and replaces the normally open contact in the prior design with the changeover contact, in which the normally closed contact of the changeover contact is connected to DC− and the normally open contact of the changeover contact is connected to DC+, and the common terminal is connected to the switch signal acquisition circuit. The advantage of this design is that it could reduce the interference in a circuit without switch signal transferred by connecting the two terminals of the acquisition circuit to DC−, which is incurred by the level changes in the other surrounding cables or by external environment. When a switch signal comes in, it is the signal terminal that changes the state of the changeover contact to open the normally closed contact and close the normally open contact. Thus a loop is formed between DC+, the closed normally open contact, the switch signal acquisition circuit, and DC−. As a result, the switch signal acquisition circuit is ON and the switch signal is reflected.

1. An anti-interference switch signal transmission circuit, including a changeover contact, a negative terminal (DC−) of a DC power supply, a positive terminal (DC+) of the DC power supply, and a switch signal acquisition circuit;
wherein the changeover contact includes a normally open contact and a normally closed contact;
wherein the changeover contact is controlled by a signal terminal to be collected;
wherein a collection terminal of the switch signal acquisition circuit is connected to a switch signal to be collected;
wherein one terminal of the switch signal acquisition circuit is linked with the positive terminal DC+ by the normally open contact, and the other terminal is connected to DC−;
wherein one terminal of the switch signal acquisition circuit is linked with the negative terminal DC− by the normally closed contact, and the other terminal is connected to DC−;
wherein when no switch signal occurs, the normally open contact open and the normally closed contact closed, the circuit level of the switch signal acquisition circuit is always in the negative DC power status; and
wherein when there are switch signal, the normally closed contact open and the normally closed open contact closed, the positive terminal DC+ is connected to the negative terminal DC− via the closed normally open contact so as to form a loop, thus the switch signal acquisition circuit is ON.

2. An anti-interference switch signal transmission circuit according to claim 1, wherein when there is no switch signal, the switch signal acquisition circuit will not be affected by outside interference thus its output state will not be charged.
